(19) United States
(12) Patent Application Publication
(10) Pub. No.: US 2005/0073629 A1
(43) Pub. Date: Apr. 7, 2005

(54) Privacy apparatus

(76) Inventors: Jing-Yi Jou, Ping Chen City (TW); Long-Hai Wu, Ping Chen City (TW); Chien-Yi Kao, Ping Chen City (TW); Ta-Wang Lai, Ping Chen City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/939,798

(22) Filed: Sep. 13, 2004

(30) Foreign Application Priority Data
Oct. 1, 2003 (TW) 92127240

(51) Int. Cl. G02F 1/1347; G02F 1/13

(52) U.S. Cl. 349/75; 349/201

(57) ABSTRACT

A privacy apparatus has a transparent substrate and a liquid crystal layer formed on the transparent substrate. A thickness of the liquid crystal layer determines a range of viewing angles for the privacy apparatus; and when the thickness is greater, the range of viewing angles is smaller. Moreover, an absorption axis of the liquid crystal layer is substantially parallel to the transparent substrate and is substantially perpendicular to the range of viewing angles.

### BACKGROUND

1. Field of Invention

The present invention relates to a light control device. More particularly, the present invention relates to a privacy apparatus that allows higher light transmission over one range of viewing angles and lower transmission over another range of viewing angles.

2. Description of Related Art

Great strides in wireless communication science and technology have produced smaller and smaller electronic components, allowing electronic devices for daily use to be smaller, thinner, more lightweight, and more exquisite, and especially have pushed the frontiers of portable electronic devices. Portable electronic devices, such as notebook computers, personal digital assistants (PDAs), and mobile telephones, are gradually becoming readily available to everyone. With widespread use comes unique security and privacy concerns for the user, especially when the user employs his portable electronic device to deal with his private affairs in a public place. A privacy apparatus is therefore desired to prevent other people from viewing the data that are displayed to the user.

Prior art has provided several privacy apparatuses to satisfy the foregoing prevention of peeping. For example, an optical grating can be formed on an anti-glare filter, which has a plurality of apertures sized in micrometers to protect secret or confidential information from prying eyes. However, the total area occupied by the apertures must exceed 50% of the anti-glare filter area in order to properly prevent peeping, and that substantially decreases the light transmission of the filter.

A multi-functional isolation filter (mirror) is disclosed in Taiwan Patent No. 314218, which is made of a reflection layer, an inner protection layer, a conductive carbon layer, an anti-peeping layer, a light absorption layer, and an outer protection layer. The anti-peeping layer is a patterned PE film, such that many corrugations are formed longitudinally on the surface of the transparent PE film. The multi-functional isolation filter has higher light transmission than the foregoing anti-glare filter with a grating, but its other functionality, including filtering UV or IR light and preventing static electricity, lowers its light transmission, makes its structure complicated, and increases its manufacturing cost.

Another conventional technique is a light control device, composed of alternating plastic layers with relatively high and relatively low optical densities. The plastic layer with high optical density comprises light-collimating louver elements. Central regions of the louvered elements have relatively high coefficients of extinction, while outer regions have relatively low coefficients of extinction.

Another light control device is disclosed in U.S. Pat. No. 6,398,370, as illustrated in FIG. 1. The light control device 100 includes two films 102 and 104. The films 102 and 104 have a plurality of grooves 112 and 114, respectively. The same or different light absorbing materials are filled into the grooves 112 and 114. The grooves 112 and 114 have included wall angles θ, which are used to control the maximum viewing range φ of the light control device 100. The light control device 100 uses the light absorbing material filled into the grooves 112 and 114 to absorb light and thereby prevent peeping.

As illustrated in FIG. 1, the viewing range φ of the light control device 100 is determined by the included wall angles θ of the upper and lower grooves 112 and 114, and the combined thickness of the two films 102 and 104. In other words, the light control device 100 must be composed of two films such that greater combined thickness effects better privacy protection. However, the greater thickness brings greater difficulty of use.

Furthermore, according to one embodiment of the aforementioned U.S. patent, the width of the grooves 112 and 114 is about 100 micrometers, the depth is about 200 micrometers, and the spacing is about 200 micrometers. Due to these small dimensions, the films 102 and 104 need to be proceeded by complicated surface techniques to form the grooves 112 and 114 during manufacturing, implying that expensive and complex manufacturing devices are needed to manufacture the light control device 100. In conclusion, the drawbacks of the conventional light control device are thickness, complicated structures, and high manufacturing cost.

### SUMMARY

It is therefore an objective of the present invention to provide a privacy apparatus that allows a user to view an image through the privacy apparatus within a range of viewing angles while blocking the viewing of the image through the privacy apparatus beyond the range of viewing angles.

It is another objective of the present invention to provide a method for manufacturing a privacy apparatus, in which a liquid crystal material is used to form a liquid crystal layer with a predetermined thickness on a transparent substrate for preventing peeping, such that the structure of the privacy apparatus is simplified and the manufacturing cost is decreased.

In accordance with the foregoing and other objectives of the present invention, a privacy apparatus is provided. A liquid crystal layer is formed on a side of a transparent substrate. A predetermined thickness of the liquid crystal layer determines the range of viewing angles, and an absorbing axis of the liquid crystal layer is substantially parallel to the transparent substrate and substantially perpendicular to the range of viewing angles, or more specifically, perpendicular to the chord of the arc swept out by the range of viewing angles.

According to one preferred embodiment of the invention, the transparent substrate comprises plastic, and the liquid crystal layer comprises discotic liquid crystal molecules. When the predetermined thickness of the liquid crystal layer is between about 4 and 20 micrometers, the range of viewing angles is between about 40 and 90 degrees.

Moreover, the liquid crystal layer comprises a plurality of liquid crystal rows that are oriented along a predetermined direction. The liquid crystal layer is formed by spreading a liquid crystal material on the side of the transparent substrate with a wire-ribbed bar, a micro gravure or a slot die, along the direction parallel to the range of viewing angles. After that, the liquid crystal layer is soaked in a chelating agent, to change the liquid crystal layer from being hydrophilic to hydrophobic. Finally, the liquid crystal layer is dried to solidify and adhere it to the transparent substrate after soaking. In this preferred embodiment, the chelating agent is a barium chloride solution with a weight percent of between 10% and 15%.

The invention can be manifested as a film adhered onto the screen of a display, or as a filter panel attached to or otherwise placed over a display screen. Additionally, the manufacturing of the privacy apparatus employs simple processes that are common to the manufacturing of liquid crystal display panels. In conclusion, the advantages of the invention are effective anti-peeping functionality, simplified structure, low manufacturing cost, and easy mass production without the need for additional manufacturing devices.

It is to be understood that both the foregoing general description and the following detailed description are examples and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a schematic view of the conventional light control device;

FIG. 2A illustrates a schematic view of one preferred embodiment of the invention;

FIG. 2B illustrates a schematic view of the manufacturing method of one preferred embodiment of the invention;

FIG. 2C illustrates a schematic view of a wire-ribbed bar being used in the preferred embodiment; and

FIG. 3 illustrates a flow chart of the preferred embodiment in FIG. 2B.

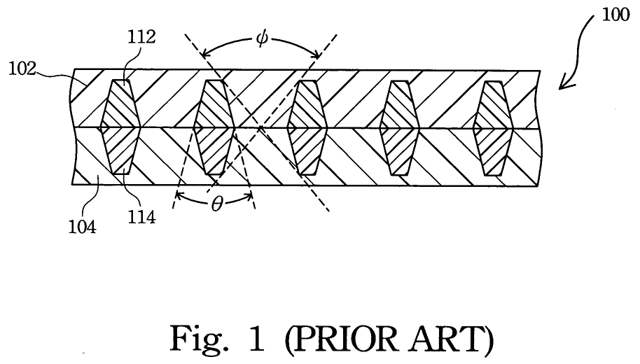

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The invention uses the absorbing axis of the liquid crystal layer to absorb light beyond the range of viewing angles and is different from the prior art, which forms a physical grating on the transparent substrate to bar peeping. The liquid crystal layer has a thickness that is predetermined to provide a certain range of viewing angles for the privacy apparatus. When the thickness is greater, the range of the viewing angles is smaller, and light with large incident angles can be almost completely absorbed along the absorbing axis of the liquid crystal layer.

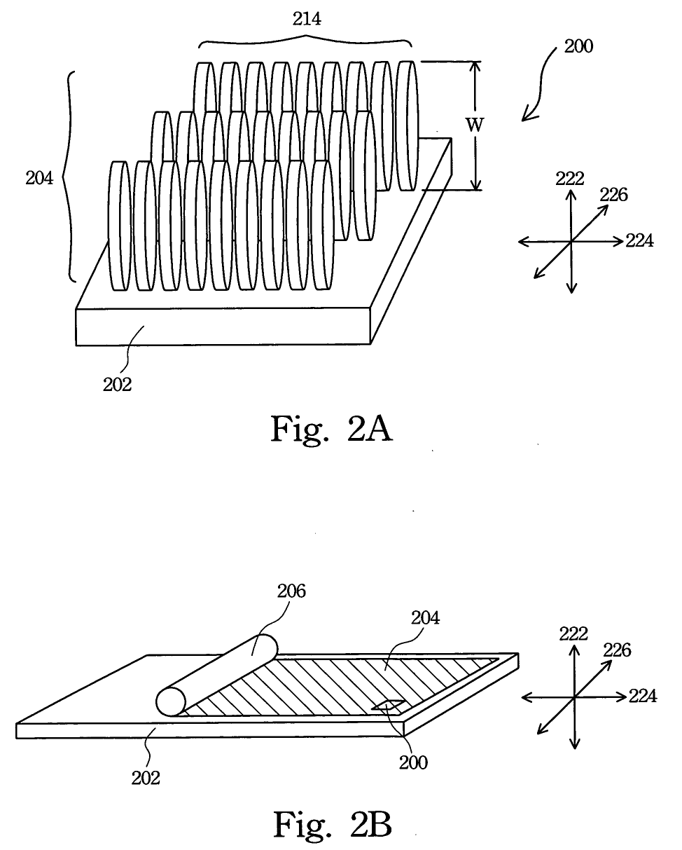

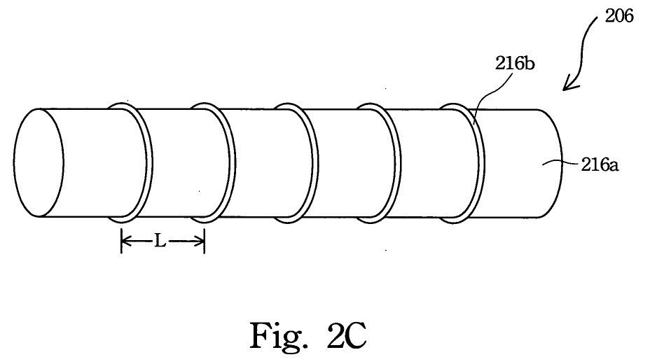

FIG. 2A illustrates a schematic view of one preferred embodiment of the invention. A privacy apparatus 200 has a transparent substrate 202 and a liquid crystal layer 204. The liquid crystal layer 204 is placed on a side of the transparent substrate 202. The material of the transparent substrate 202 can be a plastic material, such as PET, and the liquid crystal layer 204 comprises discotic liquid crystal molecules.

Generally, the discotic liquid crystal molecule comprises a rigid core, which provides the optoelectronic properties of the molecule, and flexible side chains connected around the rigid core, which facilitate the formation of the molecule and define a maximum volume of motion about the rigid core. The discotic liquid crystal molecule has unique optical properties, especially that of absorbing visible light, and therefore is a preferred material for the liquid crystal layer of the invention.

Moreover, during the formation the liquid crystal layer 204, the discotic liquid crystal molecules are self-assembled to form macromolecular structures before being completely dried, as illustrated in FIG. 2A. These discotic liquid crystal molecules stand on end and are perpendicular to the transparent substrate 202. Thus, the thickness of the liquid crystal layer 204 is increased by the discotic liquid crystal molecules, enlarging the range of light absorption. The performance of the privacy apparatus is most satisfactory when the discotic liquid crystal molecules are perfectly perpendicular to the transparent substrate 202.

In addition, the adhesive force between the liquid crystal molecules and the transparent substrate 202 is strong, which enables anti-peeping functionality by directly adjusting the thickness of the liquid crystal layer on the single transparent substrate and avoids overlaying two thick films as in the prior art. Consequently, the invention substantially decreases the thickness of the privacy apparatus.

The liquid crystal layer 204 has a predetermined thickness W in a normal direction 222 to the transparent substrate 202 and comprises a plurality of liquid crystal rows 214. The liquid crystal rows 214 are arranged parallel to a direction 224, and the absorbing axis formed by them is parallel to a direction 226. A plane formed by the direction 224 and the direction 226 is parallel to the transparent substrate 202. Since light with a polarizing direction parallel to the absorbing axis of the liquid crystal layer 204 (i.e. the direction 226) is absorbed, the direction 224, which is in plane with and perpendicular to the direction 226, is parallel to the direction of the range of viewing angles of the privacy apparatus 200. More specifically, the direction 224 is parallel to the chord of the arc swept by the range of viewing angles.

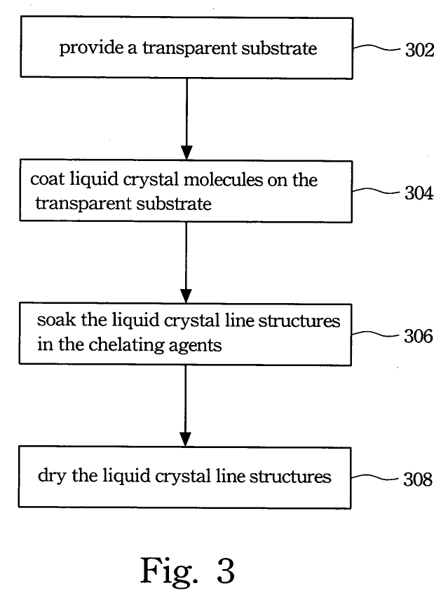

FIG. 2B illustrates a schematic view of the manufacturing method of one preferred embodiment of the invention, and FIG. 2C illustrates a schematic view of a wire-ribbed bar being used in the preferred embodiment. FIG. 3 illustrates a flow chart of the preferred embodiment in FIG. 2B. The following descriptions refer to FIG. 2B, FIG. 2C, and FIG. 3. As illustrated in FIG. 2B, the liquid crystal molecules are first placed on one end of the transparent substrate 202 (step 302). A wire-ribbed bar 206 is then pushed from the end of the substrate 202 in the direction 224 to spread the liquid crystal molecules on the transparent substrate 202, thus forming the liquid crystal layer 204 composed of a plurality of the liquid crystal rows 214 (step 304).

The wire-ribbed bar 206 illustrated in FIG. 2C, is made of a bar 216a and a wire 216b. The wire 216b is wound around the bar 216a in equidistant turns with spacing L. The wire 216b is used to define the quantity of liquid crystal molecules remaining between the wire demarcations made during spreading, such that the remaining liquid crystal molecules subsequently form liquid crystal rows.

The wire-ribbed bar 206 is a tool often used to spread liquid crystal molecules. The thickness and orientation of the liquid crystal rows are easily controlled by using the wire-ribbed bar 206 to spread the liquid crystal molecules. In this preferred embodiment, the direction 226 of the absorbing axis of the liquid crystal rows 214, which are formed by spreading using the wire-ribbed bar 206, is perpendicular to the orientation of the liquid crystal rows 214.

When the spacing L demarcated by the wire bar 206 is larger, more liquid crystal is available to self-assemble, and the resultant thickness of the liquid crystal layer 204 is greater. On the contrary, when the spacing L is smaller, the resulting thickness of the liquid crystal layer 204 is smaller. In other words, the spacing L of the wire bar 206 can be adjusted to control the thickness of the liquid crystal layer 204. As described above, the thickness of the liquid crystal layer 204 determines the range of viewing angles of the privacy apparatus. When the thickness of the liquid crystal layer 204 is greater, the range of viewing angles of the privacy apparatus is smaller; and when the thickness of the liquid crystal layer 204 is smaller, the range of viewing angles is greater. According to the preferred embodiment, when the thickness of the liquid crystal layer 204 is between about 4 and 20 micrometers, the range of viewing angles of the privacy apparatus is between about 40 and 90 degrees.

Besides the wire-ribbed bar, the liquid crystal layer 204, according to other embodiments of the invention, can be spread by a micro gravure, a slot die, or other spreading tool. The micro gravure is a patterned cylinder, which is used to roll on the surface of the transparent substrate 202 to spread liquid crystal molecules. The slot die is a patterned die, which is used to spread liquid crystal molecules on the transparent substrate 202. Therefore, the invention does not limit the manner in which the liquid crystal layer 204 is spread, and other spreading methods suitable for the invention are available to be used.

After being spread, the liquid crystal rows 214 are soaked in a chelating agent. The chelating agent changes the liquid crystal molecules from being hydrophilic to hydrophobic, thus preventing moisture in the air from affecting and damaging the liquid crystal rows 214 if environmental humidity changes. In this preferred embodiment, the chelating agent is a barium chloride solution with a weight percent between 10% and 15%, about 15% being preferred. After soaking in the barium chloride solution, the liquid crystal rows are soaked in water to remove the unused barium chloride, preventing it from leaving white deposits on the liquid crystal rows 214 during the subsequent drying process.

Finally, the liquid crystal rows 214, which have been soaked in the chelating agent, are dried to solidify and adhere them to the transparent substrate 202. The privacy apparatus is thus formed. Through the privacy apparatus, the user within the range of viewing angles can view the image but cannot view the image when outside the range of the viewing angles.

According to another preferred embodiment of the invention, the transparent substrate can be a triacetyl cellulose (TAC) substrate.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A privacy apparatus, placed between an image and a user to allow the user to view the image through the privacy apparatus within a range of viewing angles but to block the viewing of the image through the privacy apparatus beyond the range of viewing angles, the privacy apparatus comprising:
a transparent substrate; and
a liquid crystal layer placed on a side of the transparent substrate, wherein a predetermined thickness of the liquid crystal layer determines the range of viewing angles, and an absorbing axis of the liquid crystal layer is substantially parallel to the transparent substrate and perpendicular to the range of viewing angles.

2. The privacy apparatus of claim 1, wherein the liquid crystal layer comprises a plurality of liquid crystal rows oriented in a predetermined direction.

3. The privacy apparatus of claim 2, wherein the predetermined direction is substantially perpendicular to the absorbing axis.

4. The privacy apparatus of claim 1, wherein when the predetermined thickness is between about 4 and 20 micrometers, the range of viewing angles is between about 40 and 90 degrees.

5. The privacy apparatus of claim 1, wherein the transparent substrate is triacetyl cellulose (TAC) or plastic.

6. The privacy apparatus of claim 1, wherein the liquid crystal layer comprises discotic liquid crystal molecules.

7. A method for manufacturing a privacy apparatus, wherein the privacy apparatus is placed between an image and a user to allow the user to view the image through the privacy apparatus within a range of viewing angles but block the viewing of the image through the privacy apparatus beyond the range of viewing angles, the method comprising:
providing a transparent substrate; and
forming a liquid crystal layer on a side of the transparent substrate, wherein a predetermined thickness of the liquid crystal layer determines the range of viewing angles, and an absorbing axis of the liquid crystal layer is substantially parallel to the transparent substrate and perpendicular to the range of viewing angles.

8. The method of claim 7, wherein the liquid crystal layer comprises a plurality of liquid crystal rows oriented in a predetermined direction.

9. The method of claim 8, wherein the predetermined direction is substantially perpendicular to the absorbing axis.

10. The method of claim 8, wherein the liquid crystal layer is formed by spreading a liquid crystal material on the side of the transparent substrate with a wire-ribbed bar along the direction parallel to the range of viewing angles.

11. The method of claim 8, wherein the liquid crystal layer is formed by spreading a liquid crystal material on the side of the transparent substrate with a micro gravure along the direction parallel to the range of viewing angles.

12. The method of claim 8, wherein the liquid crystal layer is formed by spreading a liquid crystal material on the side of the transparent substrate with a slot die along the direction parallel to the range of viewing angles.

13. The method of claim 7, wherein the method further comprises soaking the liquid crystal layer in a chelating agent after being formed, to change the liquid crystal layer from being hydrophilic to hydrophobic.

14. The method of claim 13, wherein the chelating agent is a barium chloride solution.

15. The method of claim 14, wherein a weight percent of the barium chloride solution is between 10% and 15%.

16. The method of claim 13, wherein the method further comprises drying the liquid crystal layer to solidify and adhere the liquid crystal layer onto the transparent substrate after soaking the liquid crystal layer in the chelating agent.

17. The method of claim 7, wherein when the predetermined thickness is between about 4 and 20 micrometers, the range of viewing angles is between about 40 and 90 degrees.

18. The method of claim 7, wherein the transparent substrate is triacetyl cellulose (TAC) or plastic.

19. The method of claim 7, wherein the liquid crystal layer comprises discotic liquid crystal molecules.
